(19) United States
(12) Patent Application Publication
(10) Pub. No.: US 2014/0031018 A1
(43) Pub. Date: Jan. 30, 2014

(54) ONE-BUTTON FORMATION OF A PROXIMITY BASED INSTANT TEMPORARY SOCIAL NETWORK ON MOBILE DEVICES

(71) Applicant: Bryan K. Hughes, San Francisco, CA (US)

(72) Inventor: Bryan K. Hughes, San Francisco, CA (US)

(73) Assignee: Go Factory, LLC, San Francisco, CA (US)

(21) Appl. No.: 13/951,201

(22) Filed: Jul. 25, 2013

Related U.S. Application Data
(60) Provisional application No. 61/676,045, filed on Jul. 26, 2012.

(51) Int. Cl. H04W 4/02

(52) U.S. Cl. CPC H04W 4/023
USPC 455/414.3

(57) ABSTRACT

A method and apparatus for creating and managing proximity based instant temporary social networks with group communication is provided. With the press of a single button, an instant social network is established with users within a specific proximity based on latitude and longitude location and audio fingerprint detection as determined by the users mobile device. Once the group has formed, group communications are offered as a means to facilitate keeping the group together while achieving a goal, such as a group destination.

### BACKGROUND

This invention provides a software solution for the real-time proximity based formation of an instant temporary social network on mobile devices.

The present invention is in the technical field of mobile devices, or, more specifically, methods and systems for group formation, communication and tracking.

Trying to get a group of people of any size anywhere is hard and often a very frustrating endeavor that often results in a bad or stressful experience. Typically, the first near impossible step is picking someplace to go. The second is keeping track of everyone while trying to get there. Inevitably, people are lost along the way, either through miscommunication, loss of interest, or change in plans.

### SUMMARY

Considered broadly, the present invention is a set of computational and programmatic electronic methods to allow the formation of an instant temporary social network for the purposes of solving the problem of how to get a group of people somewhere to do something without having to create an account or even belong to an external site such. The invention allows each user to track each other while in the networked group, while providing group communication such as chat and push-to-talk.

Other principal features and advantages of the invention will become apparent to those skilled in the art upon review of the following drawings, the detailed description, and the appended claims.

### BRIEF DESCRIPTION OF THE DRAWINGS

Example embodiments will hereafter be described with reference to the accompanying drawings, wherein like numerals denote like elements. The drawings depict example embodiments in accordance with the disclosure and are, therefore, not to be considered limiting of its scope.

FIG. 1 is a high level diagram of the present invention in accordance with an example embodiment.

FIG. 2 depicts a flow diagram illustrating the one-button proximity based system of forming an instant social network of mobile users on a mobile device using a wireless network.

FIG. 3 depicts a functional block diagram for the server side system of the one button formation of a temporary instant social network.

### DETAILED DESCRIPTION

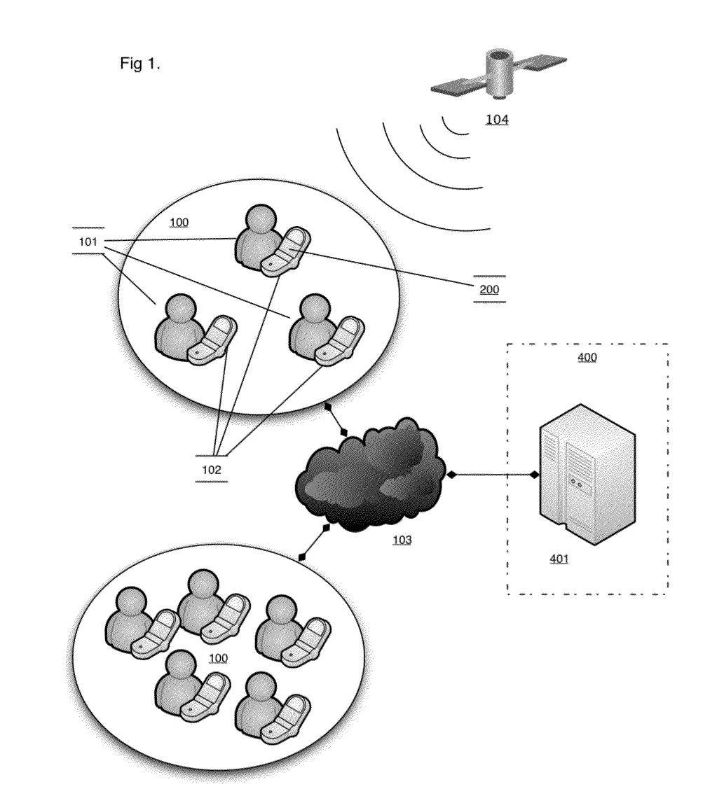

Referring now to the invention in more detail, in FIG. 1, a high level diagram of the invention is shown in accordance with an example embodiment. The invention includes a group management and communication system for mobile device with Global Positioning System and wireless networking technologies 102, which is composed of a plurality of mobile user 101 who wish to form a temporary social network 100. The invention includes mobile application system 200, a data processing system 400, and a network 103. Network 103 may include one or more networks of the same or different types. Network 103 can be any type of wireless public or private network including a cellular network, a local area network, a wide area network such as the Internet, etc. Network 103 further may be comprised of sub-networks and consist of any number of devices.

The data processing system 400 includes a server computing device 401 and a HTTP or socket connection. Server computing device 401 may be a computer of any form factor. The data processing system accepts HTTP or socket connections from any plurality of mobile device 102. Mobile device may include any device supporting GPS 104 and wireless networking not limited to those devices running iOS, Android, WebOS, or Windows.

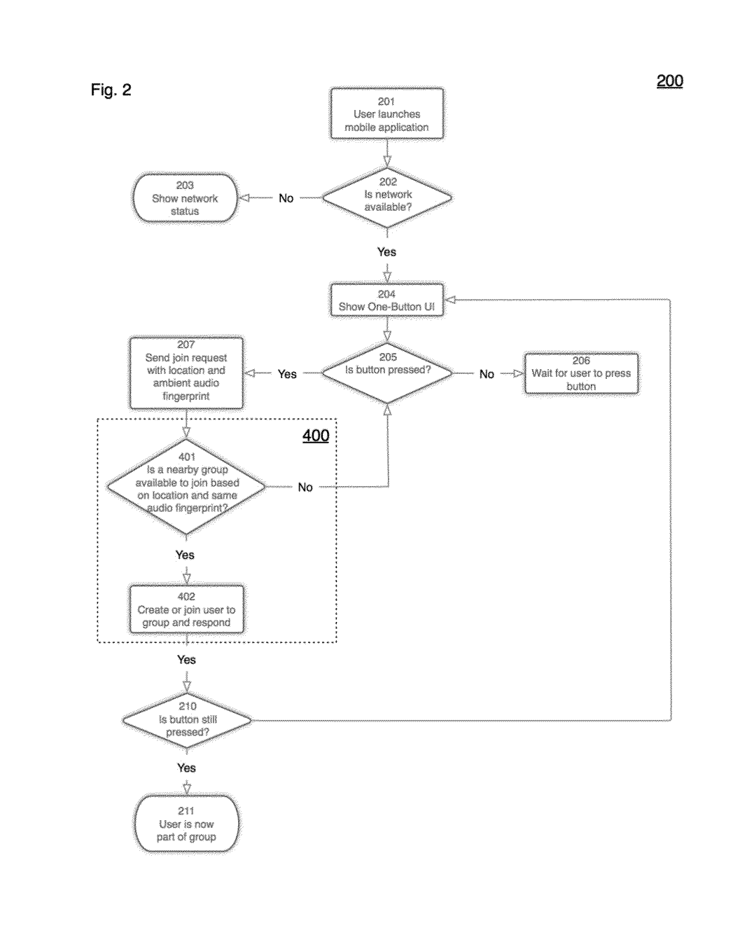

In more detail, still referring to the invention of FIG. 2, example operations associated with instant social network application 200. Additional, fewer, or different operations may be performed depending on the embodiment. The order of presentation of the operations of FIG. 2 is not intended to be limiting. In addition, although some of the operational flows are presented in sequence, the various operations may be performed in various repetitions, concurrently, and/or in other orders than those that are illustrated.

In instant social network application 200, in an operation the user launches the mobile application 201 on their mobile device. In an operation 202, the network is tested to be available.

In an operation 203, if network is not available, network status is shown. Otherwise, in an operation 204, the application displays the one-button screen. In an operation 205, if button is pressed, a join request with the latitude and longitude as reported by the mobile devices location sensor comprised with of GPS and/or wireless, and an audio fingerprint recorded from the onboard microphone is transmitted to the server.

In an operation 401, the server compares all join requests at the same time by location as reported by each instant social networking application 200 and ambient audio fingerprint. If join requests are within proximity of each other and the audio fingerprint matches, an instant social network is formed.

In an operation 402, as a plurality of nearby mobile device 200 submit join requests where each are within a proximity as determined by GPS and/or wifi location and a match of ambient fingerprints, each mobile device is added to the instant group.

In an operation 210, if button is still being pressed while instant social network is forming, mobile application 200 accepts the response and user is joined to the group. If the button is released prior to acknowledgement from the server, the mobile application reverts back to operation 204 displaying a single button.

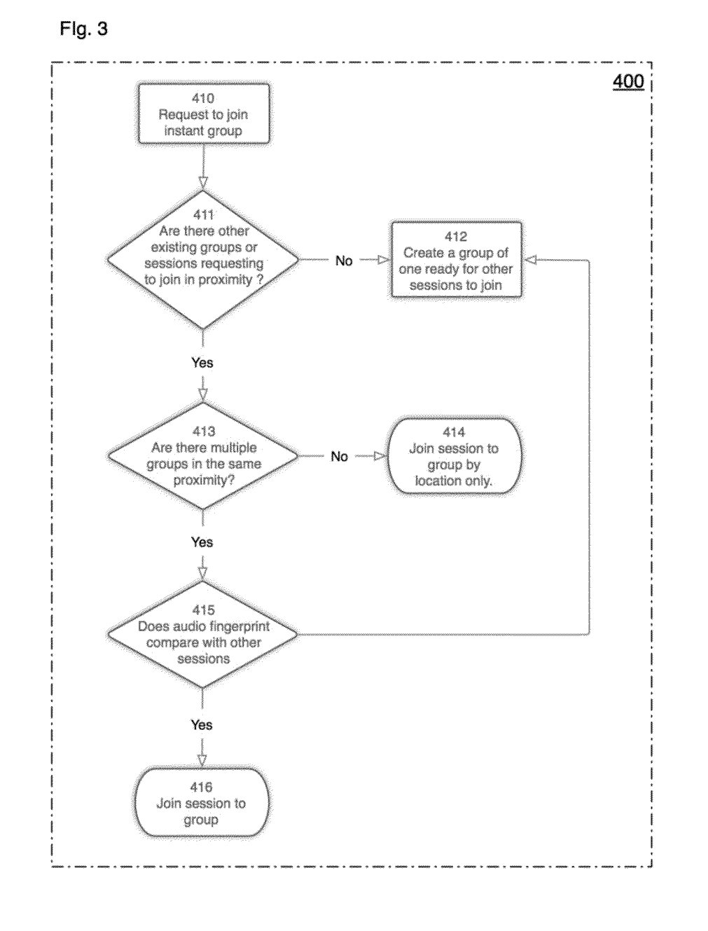

In further detail, still referring to the invention of FIG. 3, example operations associated with data processing system 400. Additional, fewer, or different operations may be performed depending on the embodiment. The order of presentation of the operations of FIG. 3 is not intended to be limiting. In addition, although some of the operational flows are presented in sequence, the various operations may be performed in various repetitions, concurrently, and/or in other orders than those that are illustrated.

In data processing system 400, in an operation a user requests to form an instant temporary social network.

In an operation 411, data processing system 400 accepts network requests via either an HTTP or socket connection from mobile application 200. Based on the latitude and longitude proximity of the device, data processing system 400 first determines if there are any existing social networks in the process of forming within the proximity. If none are present, a new group is created ready to accept other join requests in the same proximity matching the same audio fingerprint as identified by operation 412.

In operation 413, if multiple groups overlap in the same proximity, data processing system 400 evaluates the ambient audio fingerprint to further identify the locality of each mobile device. Otherwise as specified by operation 414, if no groups are available either existing or by failure of ambient audio fingerprint comparison, data processing 400 creates a group with mobile application 200 as the first member ready for other sessions to join.

In operation 415, if multiple groups' overlap in the same proximity and ambient audio fingerprint matches with a group, data processing 400 joins mobile application 200 to group as identified in operation 416. Otherwise, if ambient audio fingerprints do not match, a new group is created ready to accept other join requests in the same proximity matching the same audio fingerprint as identified by operation 412.

The word “example” is used herein to mean serving as an example, instance, or illustration. Any aspect or design described herein as “example” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise. The example embodiments may be implemented as a method, apparatus, or article of manufacture using standard programming and/or engineering techniques to produce software, firmware, hardware, or any combination thereof to control a computer to implement the disclosed embodiments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for selectively forming a network of mobile devices, the mobile devices comprising a display and a microphone, the method comprising:
displaying a button on the display of the mobile devices, wherein the button has a pressed state and a released state;
recording an audio fingerprint from the microphone in a first mobile device when the button displayed on the display of the first mobile device is in the pressed state;
recording an audio fingerprint from the microphone in a second mobile device when the button displayed on the display of the second mobile device is in the pressed state;
providing a latitude and a longitude coordinate corresponding to a location of the first mobile device;
providing a latitude and a longitude coordinate corresponding to a location of the second mobile device; and
joining the second mobile device with the first mobile device to form the network when the second mobile device is within proximity of the first mobile device and when the audio fingerprint recorded from the microphone in the second mobile device matches the audio fingerprint recorded from the microphone in the first mobile device.

2. The method of claim 1 wherein the method further comprises a method for selectively forming a wireless network and wherein the joining step further comprises joining the second mobile device with the first mobile device when the second mobile device is within proximity of the first mobile device and when the audio fingerprint recorded from the microphone in the second mobile device matches the audio fingerprint recorded from the microphone in the first mobile device.

3. The method of claim 1 wherein the method further comprises a method for selectively forming a cellular network and wherein the joining step further comprises joining the second mobile device with the first mobile device when the second mobile device is within proximity of the first mobile device and when the audio fingerprint recorded from the microphone in the second mobile device matches the audio fingerprint recorded from the microphone in the first mobile device.

4. The method of claim 1 wherein the method further comprises a method for selectively forming a wide area network and wherein the joining step further comprises joining the second mobile device with the first mobile device when the second mobile device is within proximity of the first mobile device and when the audio fingerprint recorded from the microphone in the second mobile device matches the audio fingerprint recorded from the microphone in the first mobile device.

5. The method of claim 1 wherein the method further comprises a method for selectively forming a local area network and wherein the joining step further comprises joining the second mobile device with the first mobile device when the second mobile device is within proximity of the first mobile device and when the audio fingerprint recorded from the microphone in the second mobile device matches the audio fingerprint recorded from the microphone in the first mobile device.

6. The method of claim 1 further comprising a third mobile device, the third mobile device comprising a display and a microphone, the method comprising:
displaying a button on the display of the third mobile device, wherein the button has a pressed state and a released state;
recording an audio fingerprint from the microphone in the third mobile device when the button displayed on the display of the third mobile device is in the pressed state;
providing a latitude and a longitude coordinate corresponding to a location of the third mobile device; and
joining the third mobile device to the network with the first and second mobile devices when the third mobile device is within proximity of the first and second mobile devices and when the audio fingerprint recorded from the microphone in the third mobile device matches the audio fingerprints recorded from the microphone in the first mobile device and from the microphone in the second mobile device.

7. A system for selectively forming a network of mobile devices, the system comprising:
a plurality of mobile devices, wherein the mobile devices further comprise a display, a microphone and a global positioning system;
a button displayed on the displays of the mobile devices, wherein the button has a pressed state and a released state;
wherein a first mobile device is configured to record an audio fingerprint from the microphone when the button displayed on the display of the first mobile device is in the pressed state;
wherein a second mobile device is configured to record an audio fingerprint from the microphone when the button displayed on the display of the second mobile device is in the pressed state; and
a server configured to receive the audio fingerprint recorded from the microphone in the first mobile device and the audio fingerprint recorded from the microphone in the second mobile device;
wherein the server is further configured to receive a latitude and a longitude coordinate corresponding to a location of the first mobile device from the global positioning system in the first mobile device;
wherein the server is further configured to receive a latitude and a longitude coordinate corresponding to a location of the second mobile device from the global positioning system in the second mobile device; and
wherein the server is further configured to form a network between the second mobile device and the first mobile device when the second mobile device is within proximity of the first mobile device and when the audio fingerprint recorded from the microphone in the second mobile device matches the audio fingerprint recorded from the microphone in the first mobile device.

8. The system of claim 7 wherein the network further comprises a wireless network.

9. The system of claim 8 wherein the network further comprises a cellular network.

10. The system of claim 7 wherein the network further comprises a wide area network.

11. The system of claim 7 wherein the network further comprises a local area network.

12. The system of claim 7 wherein the plurality of mobile devices run an iOS, Android, WebOS or Windows operating system.

13. The system of claim 7 further comprising:
a third mobile device comprising a display, a microphone and a global positioning system;
a button displayed on the display of the third mobile device, wherein the button has a pressed state and a released state;
wherein the third mobile device is configured to record an audio fingerprint from the microphone when the button displayed on the display of the third mobile device is in the pressed state;
wherein the server is further configured to receive the audio fingerprint recorded from the microphone in the third mobile device;
wherein the server is further configured to receive a latitude and a longitude coordinate corresponding to a location of the third mobile device from the global positioning system in the third mobile device; and
wherein the server is configured to join the third mobile device to the network with the first and second mobile devices when the third mobile device is within proximity of the first and second mobile devices and when the audio fingerprint recorded from the microphone in the third mobile device matches the audio fingerprint recorded from the microphone in the first mobile device and the audio fingerprint recorded from the microphone in the second mobile device.
